(19) United States
(12) Patent Application Publication
(10) Pub. No.: US 2013/0067117 A1
(43) Pub. Date: Mar. 14, 2013

(54) EXPANSION INPUT/OUTPUT DEVICE

(71) Applicants: KUO-CHAN PENG, Pingzhen City (TW); CHING-FENG HSIEH, Taipei City (TW)

(72) Inventors: KUO-CHAN PENG, Pingzhen City (TW); CHING-FENG HSIEH, Taipei City (TW)

(73) Assignees: ASKEY COMPUTER CORP.; ASKEY TECHNOLOGY (JIANGSU) LTD.

(21) Appl. No.: 13/280,375

(22) Filed: Oct. 25, 2011

(30) Foreign Application Priority Data
Sep. 9, 2011 (TW) 100132754

(51) Int. Cl. G06F 3/00

(52) U.S. Cl. 710/2

(57) ABSTRACT

An expansion input/output device includes a body having a receiving space, an input unit, a second transmission unit, and a third transmission unit. A handheld electronic device can be received in the receiving space and functions as a computation processing center. The expansion input/output device integrates an input function of the input unit to provide a user-friendly input interface, and sends an audio/video signal of the handheld electronic device from a first transmission unit of the handheld electronic device to an external display device through the second transmission unit and the third transmission unit to provide a large display view. The expansion input/output device expands the applicability and integration capacity of the handheld electronic device and enhances ease of use thereof.

### CROSS-REFERENCE TO RELATED APPLICATION

This non-provisional application claims priority under 35 U.S.C. §119(a) on Patent Application No(s). 100132754 filed in Taiwan, R.O.C. on Sep. 9, 2011, the entire contents of which are hereby incorporated by reference.

### FIELD OF TECHNOLOGY

The present invention relates to expansion input/output devices, and more particularly, to an expansion input/output device that can be coupled to a handheld electronic device.

### BACKGROUND

Due to technological advancement and rapid development of the electronic industry, handheld electronic devices nowadays are robust and capable of basic computation and thus can provide multimedia entertainment or computerized computation when operated and controlled by users. In recent years, handheld electronic devices overwhelmingly come in the form of smartphones capable of communication and computation. Smartphones are catching up with computers in performance and functions. Hence, smartphones have become indispensable necessities of life today and can substitute for computers when it comes to certain computer functions.

However, due to communication-related and mobility-related limitations of smartphones, smartphones typically have a screen which is five inches or less in dimensions, thereby placing a limitation on the size of an input interface or a virtual keyboard provided on the screen. Likewise, due to the limitation of the dimensions of the screen of smartphones, smartphones are outperformed by tablet computers, notebook computers, desktop computers which have a large display view in work or entertainment.

To enhance the applicability of a portable smartphone in a specific venue, the smartphone is connected to an external peripheral device. For example, the smartphone is connected to an external display device for enlarging the display view of the smartphone. Alternatively, the smartphone is connected to an external touch display device for not only enlarging the display view but also performing touch control and input functions through the touch display device to thereby provide a large input interface to enhance ease of use.

Although smartphones simulate an input interface for the keyboard and cursor of a computer by means of touch control, use of smartphones is hardly easy because of the limitation of the size of input interface which is in turn attributed to the limitation of the dimensions of the screen of the smartphones. As a result, to gain access to a large input interface for use with a smartphone, it is common to connect the smartphone to an external touch display screen rather than convenient computer peripheral devices, such as a keyboard and a mouse. To work or have fun, users usually need a large display screen and operation screen, which are typically provided on tablet computers and notebook computers conveniently, as opposed to the hassles of connecting a smartphone to external peripheral devices.

The above-mentioned illustrates some of the differences between computer products, such as tablet computers and notebook computers, and handheld electronic device, such as smartphones, in terms of use requirements and mobility. However, in undeveloped or resource-deficient regions/countries, when it comes to consumer electronic products and home appliances, cell phones and television screens have priority over tablet computers or notebook computers among consumers. In this situation, there is a need for an expansion input/output device capable of integrating a cell phone and a conventional computer or a television screen to provide a large display screen, perform computation through an input interface, enhance the applicability and integration capacity of cell phones, enhance user-friendliness, and enhance the standards of living in undeveloped or resource-deficient regions/countries.

### SUMMARY

It is an objective of the present invention to provide an expansion input/output device for being coupled to a handheld electronic device such that the handheld electronic device is connected to a display screen for displaying a view thereon.

Another objective of the present invention is to provide an expansion input/output device capable of treating the handheld electronic device as a computation processing center, integrating an input function and an output function, and expanding the applicability and integration capacity of the handheld electronic device.

In order to achieve the above and other objectives, the present invention provides an expansion input/output device electrically connected to a display device and coupled to a handheld electronic device. The handheld electronic device comprises a first transmission unit. The handheld electronic device generates an audio/video signal. The an expansion input/output device comprises: a body having a receiving space for receiving the handheld electronic device; an input unit disposed on the body for generating a control signal based on an input entered by a user; a second transmission unit disposed on the body and electrically connected to the input unit and the first transmission unit for transmitting the control signal and receiving the audio/video signal and thereby controlling and operating the handheld electronic device based on the control signal; and a third transmission unit disposed on the body and electrically connected to the second transmission unit and the display device for transmitting the audio/video signal to the display device and displaying the audio/video signal on the display device.

Regarding the expansion input/output device, the third transmission unit comprises a signal converter for performing a conversion process on the audio/video signal based on a transmission interface of the display device. The transmission interfaces of the display device are wired transmission interfaces or wireless transmission interfaces. For example, the transmission interfaces of the second transmission unit and the display device include an HDMI, a VGA interface, a DVI, a DisplayPort, a USB interface, a Bluetooth interface, an NFC interface, an AV terminal interface, an S terminal interface, and/or a chromatic aberration terminal interface.

Regarding the expansion input/output device, the input unit is a computer peripheral input device. For example, the input unit is a keyboard, a games controller, a hand-writing panel, or a mouse.

Regarding the expansion input/output device, wired transmission interfaces or wireless transmission interfaces are disposed between the first transmission unit and the second transmission unit. For example, the transmission interfaces of the first transmission unit and the second transmission unit include an HDMI, a VGA interface, a DVI, a DisplayPort, a USB interface, a Bluetooth interface, and/or an NFC interface.

Regarding the expansion input/output device, the display device is a television screen, a liquid crystal display, or a plasma display.

The expansion input/output device further comprises a clamping unit disposed in the receiving space and having at least one adjusting member for adjusting the clamping unit and thereby clamping and fixing the handheld electronic device.

Accordingly, the present invention provides an expansion input/output device coupled to a handheld electronic device for treating the handheld electronic device as a computation processing center, integrating the input function of the input unit to effectuate a user-friendly input interface, sending an audio/video signal of the handheld electronic device to an external display device, so as to provide a large display view, expand the applicability and integration capacity of the handheld electronic device, and enhance ease of use. Hence, users will find the expansion input/output device of the present invention useful and convenient, such that a handheld electronic device with high mobility can work as efficiently as the hardware system of a personal computer.

### BRIEF DESCRIPTION

Objectives, features, and advantages of the present invention are hereunder illustrated with specific embodiments in conjunction with the accompanying drawings, in which:

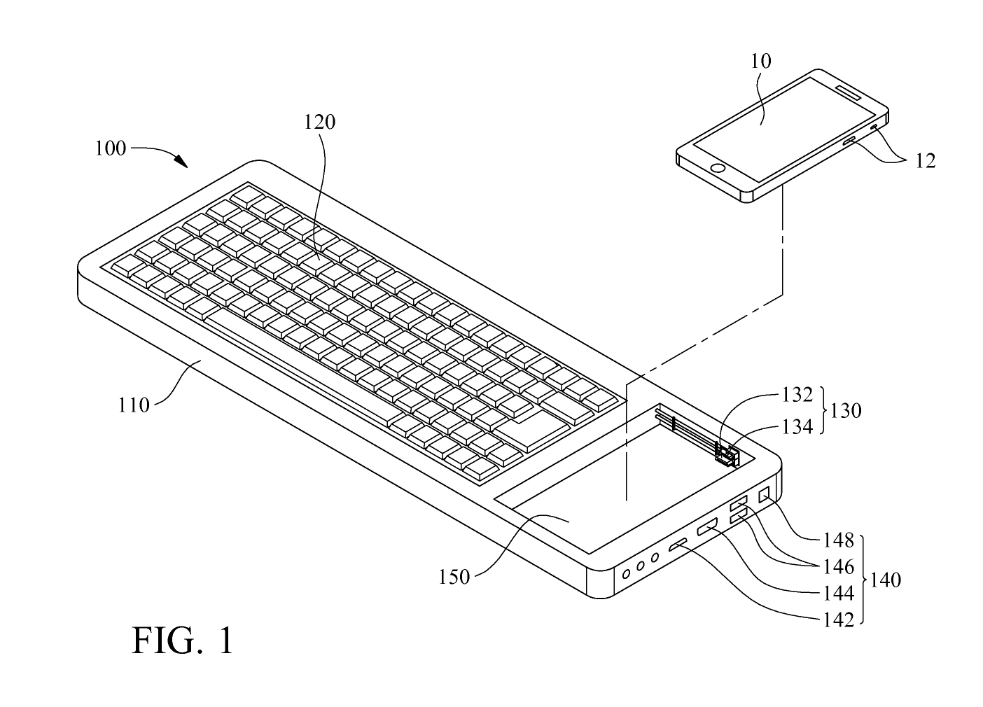

FIG. 1 is a schematic view of an expansion input/output device according to the first embodiment of the present invention;

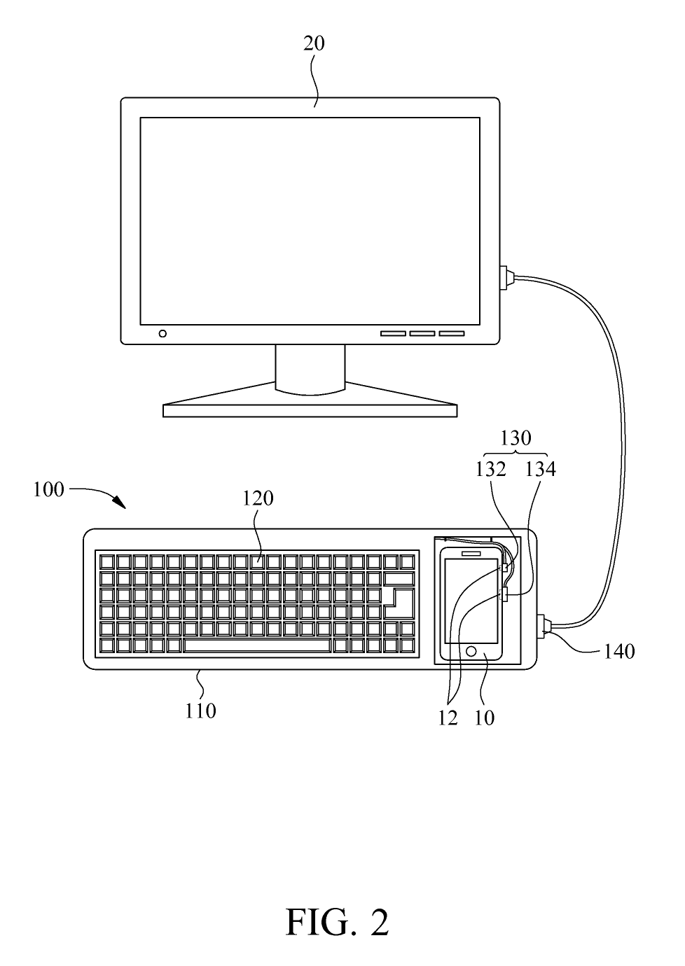

FIG. 2 is a schematic view of the expansion input/output device coupled to a handheld electronic device and externally connected to a display device according to the first embodiment of the present invention;

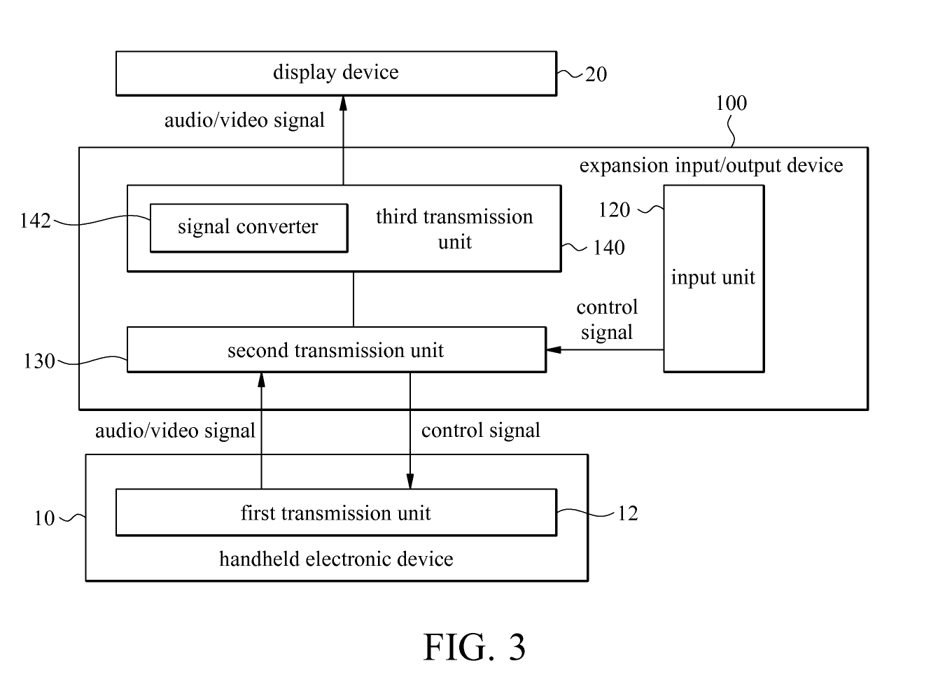

FIG. 3 is a schematic view of transmission of an audio/video signal and a control signal between the handheld electronic device and the display device connected to the expansion input/output device according to the first embodiment of the present invention;

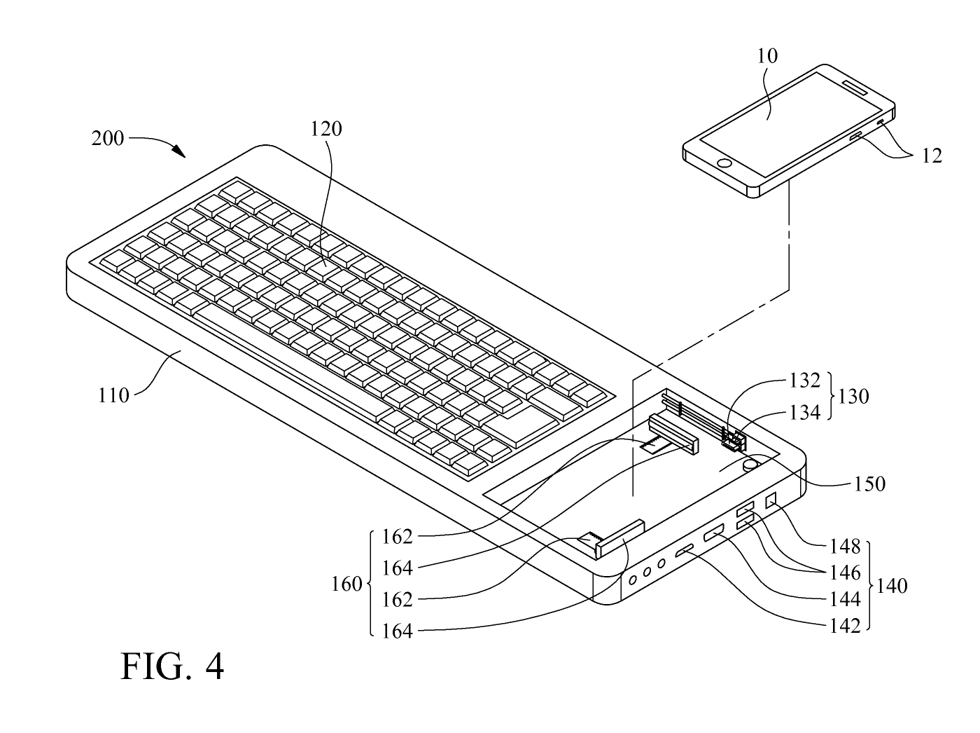

FIG. 4 is a schematic view of an expansion input/output device according to the second embodiment of the present invention;

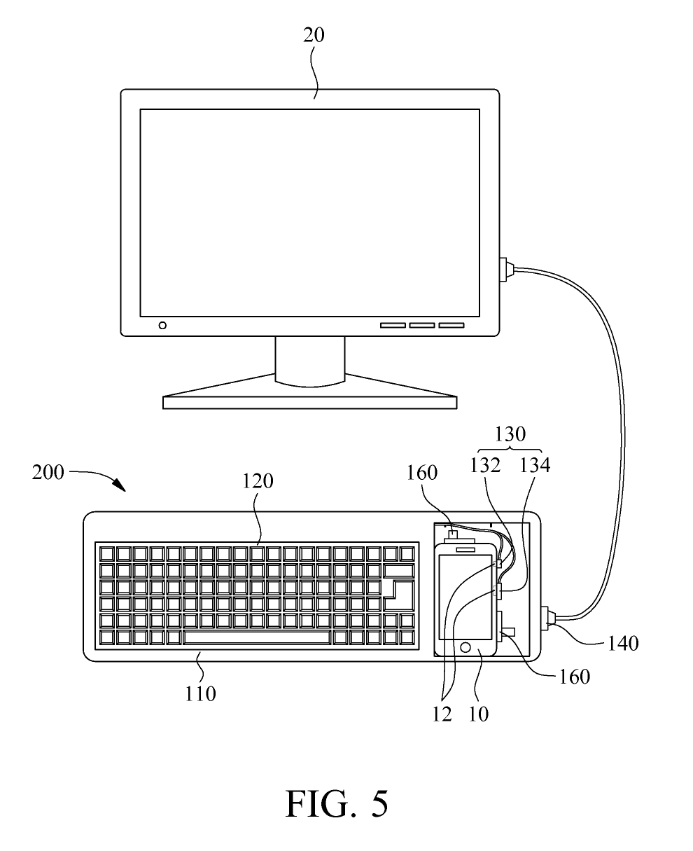

FIG. 5 is a schematic view of the expansion input/output device coupled to a handheld electronic device and externally connected to the display device according to the second embodiment of the present invention; and

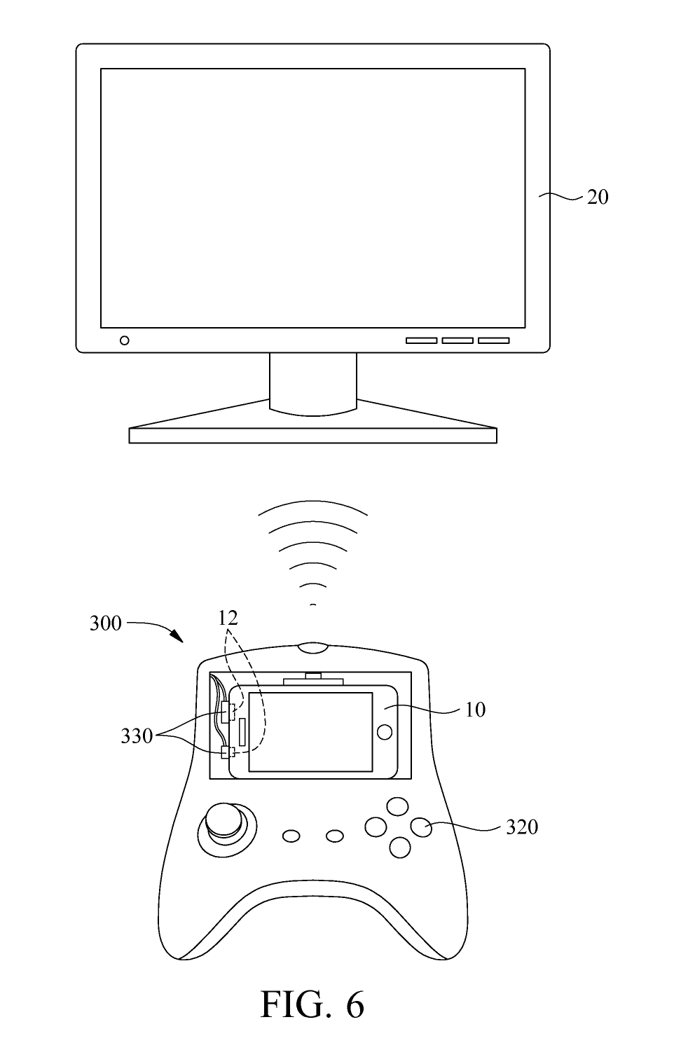

FIG. 6 is a schematic view of an expansion input/output device according to a variant embodiment of the present invention.

### DETAILED DESCRIPTION

Referring to FIG. 1 through FIG. 3, there are shown schematic views of an expansion input/output device 100 according to the first embodiment of the present invention. The expansion input/output device 100 has an audio/video transmitting/receiving function and an input/output function, and can be coupled to a handheld electronic device 10 to treat the handheld electronic device 10 as a computation processing center. The handheld electronic device 10 comprises a first transmission unit 12. The handheld electronic device 10 generates an audio/video signal. Then, the first transmission unit 12 transmits the audio/video signal. In this embodiment, the handheld electronic device 10 is exemplified by a smartphone equipped with a computation unit (not shown) and a display unit (not shown), wherein the display unit is capable of touch control, and thus the handheld electronic device 10 functions as a computation processing center comparable to a central processing unit (CPU) of a computer for operating and controlling the handheld electronic device 10 when operated by a user. However, the disclosure contained in the present invention is not limited to the handheld electronic device 10; instead, the handheld electronic device 10 of the present invention can be replaced with a personal digital assistant (PDA) capable of computation.

The expansion input/output device 100 according to the first embodiment of the present invention comprises a body 110, an input unit 120, a second transmission unit 130, and the third transmission unit 140. The body 110 has a receiving space 150. The receiving space 150 receives the handheld electronic device 10. The input unit 120 is disposed on the body 110 and adapted to generate a control signal according to an input entered by a user. The second transmission unit 130 is disposed on the body 110 and electrically connected to the input unit 120 and a first transmission unit 12 of the handheld electronic device 10 for transmitting the control signal and receiving the audio/video signal. The third transmission unit 140 is disposed on the body 110 and electrically connected to the second transmission unit 130 and a display device 20 for transmitting the audio/video signal to the display device 20 and displaying the audio/video signal on the display device 20.

The handheld electronic device 10 is received in the receiving space 150. The first transmission unit 12 of the handheld electronic device 10 is electrically connected to the second transmission unit 130, such that the control signal from the input unit 120 can be sent to the first transmission unit 12 via the second transmission unit 130 to control and operate the handheld electronic device 10 according to an input entered into the input unit 120 by the user; meanwhile, the handheld electronic device 10 functions as a computation processing center comparable to the central processing unit (CPU) of a computer and executes the control and operation instructions entered by the user. Once the third transmission unit 140 is electrically connected to the display device 20, the audio/video signal of the handheld electronic device 10 will be sent to the display device 20 via the first transmission unit 12, the second transmission unit 130, and the third transmission unit 140 such that the audio/video signal will be displayed on the display device 20. Hence, it is feasible to display a view on the display device 20 by operating an operation interface (such as a touch screen or a key) of the input unit 120 and the handheld electronic device 10 and treating the handheld electronic device 10 as a computation processing center intended for operation and control.

In this embodiment, the receiving space 150 is a receiving chamber disposed on the body 110. The handheld electronic device 10 can be either coupled to or embedded in the receiving space 150 in a manner that the display screen of the handheld electronic device 10 faces upward such that the touchscreen function and the keying function of the handheld electronic device 10 are accessible simultaneously.

In this embodiment, as shown in FIG. 2, the transmission interfaces of the first transmission unit 12 and the second transmission unit 130 are exemplified by wired transmission interfaces. The first transmission unit 12 of the handheld electronic device 10 comprises an HDMI transmission jack and a USB transmission jack for transmitting the audio/video signal or other signals. The second transmission unit 130 comprises an HDMI port 132 and a USB port 134 which are connected to each other by a transmission line for carrying out signal transmission. The second transmission unit 130 can be disposed inside the receiving space 150 or disposed in the vicinity of the receiving space 150. The wired transmission interface can come in the form other than the aforesaid HDMI interface or USB interface; for example, the wired transmission interface includes any transmission interfaces, such as VGA (Video Graphics Array), DVI (Digital Visual Interface), or DisplayPort.

Signal transmission between the first transmission unit 12 and the second transmission unit 130 is not restricted to wired transmission; instead, it includes wireless transmission as well. For example, the expansion input/output device 100 and the handheld electronic device 10 can have a wireless transmission interface, such as a Bluetooth interface or an NFC (Near Field Communication) interface, such that a wireless transmission interface module (not shown) is disposed on a built-in circuit board (not shown) in the body 110 of the expansion input/output device 100 for performing signal transmission between the expansion input/output device 100 and the handheld electronic device 10, thereby dispensing with a transmission line and a transmission connector.

In this embodiment, the display device 20 is a television screen, a liquid crystal display, or a plasma display. The transmission interface of the display device 20 is a wired transmission interface or a wireless transmission interface. The wired transmission interface includes an HDMI interface, a VGA interface, a DVI, a DisplayPort interface, a USB interface, an AV terminal interface, an S terminal interface, or a chromatic aberration terminal interface. The wireless transmission interface includes a Bluetooth interface or an NFC interface. Hence, the third transmission unit 140 can have a corresponding transmission interface, such as an HDMI port 142, a DVI port 144, a USB port 146, or any other transmission interface port 148. Alternatively, the third transmission unit 140 comprises a wireless transmission interface module (not shown) disposed on a built-in circuit board in the body 110 for sending the audio/video signal to the display device 20 and displaying the view thereon.

As shown in FIG. 3, the third transmission unit 140 comprises a signal converter 142 for performing a conversion process on the audio/video signal in accordance with the transmission interface of the display device 20. For example, the display device 20 is a liquid crystal display (LCD) equipped with a wireless transmission interface, such as a Bluetooth interface. If the transmission interface for the first transmission unit 12 of the handheld electronic device 10 is an HDMI transmission jack, the second transmission unit 130 of the expansion input/output device 100 can be connected to the first transmission unit 12 by means of an HDMI connector, to effect the following: sending an audio/video signal of the handheld electronic device 10 to the second transmission unit 130 via the first transmission unit 12 under an HDMI protocol; converting the protocol for the audio/video signal into a Bluetooth protocol by the signal converter 142; and sending the audio/video signal to the display device 20 by the third transmission unit 140 having a Bluetooth transmission interface under the Bluetooth protocol and thereby displaying the audio/video signal on the display device 20.

Referring to FIG. 4 and FIG. 5, there are shown schematic views of an expansion input/output device 200 according to the second embodiment of the present invention. In the second embodiment, a clamping unit 160 is disposed in the receiving space 150 of the expansion input/output device 200. The clamping unit 160 clamps the handheld electronic device 10. The clamping unit 160 comprises adjusting members 162 for adjusting the clamping unit 160 to the size of the handheld electronic device 10 and thereby clamping and fixing the handheld electronic device 10. For example, as shown in FIG. 4 and FIG. 5, the clamping unit 160 comprises the adjusting members 162 and two clamping members 164. The adjusting members 162 include racks or gears disposed in the receiving space 150 and racks disposed on the clamping members 164. The rack-to-rack relative motion or the gear-to-rack relative motion enables the clamping members 164 to perform linear motion and thus can be moved closer to each other or moved away from each other, thereby adjusting the clamping unit 160 to the size of the handheld electronic device 10. Furthermore, the clamping unit 160 comprises a fixing structure, such as an engaging structure or a locking structure, whereby the clamping members 164 thus adjusted are fixed in place for holding the handheld electronic device 10 firmly. Hence, the expansion input/output device 200 is applicable to the handheld electronic device 10 that comes in any dimensions and is capable of holding the handheld electronic device 10 firmly, such that the handheld electronic device 10 is fixed to the expansion input/output device 200 for use by a user. With the handheld electronic device 10 being coupled to the expansion input/output device 200 and being treated as a computation processing center, it is feasible for the expansion input/output device 200 to execute the control and operation instructions entered into the input unit 120 by the user. The expansion input/output device 200 is connected to the external display device 20, such that the results of control, operation, and computation can be sent to the display device 20 and displayed thereon.

In the first and second embodiments, the input unit 120 is exemplified by a computer keyboard whereby a user presses a key thereon to generate the control signal and send the control signal to the first transmission unit 12 of the handheld electronic device 10 via the second transmission unit 130, such that the user can control and operate the handheld electronic device 10 according to an input entered into the input unit 120 by the user.

However, the computer keyboard in the aforesaid embodiments is not intended to limit the present invention; instead, the input unit 120 can come in the form of any other computer peripheral input device. For example, the input unit 120 can be any personal computer peripheral input device, such as a games controller, a hand-writing panel, or a mouse, so that the user can press a functional key on the personal computer peripheral input device to key in a control instruction. For example, as shown in FIG. 6 that illustrates a variant embodiment of the present invention, an example is taken of the input unit 320 of an expansion input/output device 300 having a games controller embedded therein, the handheld electronic device 10 functions as a computation processing center for executing the control signal generated by the input unit 320 according to an input entered by the user and displaying the result of execution of the control signal on the display device 20, whether the display device 20 is connected to the expansion input/output device 300 by wired connection or wireless connection. In a way similar to the aforesaid embodiments, matched transmission interfaces are disposed between the first transmission unit 12 of the handheld electronic device 10 and the second transmission unit 330 of the expansion input/output device 300 and disposed between the third transmission unit (not shown) of the expansion input/output device 300 and the display device 20. The transmission interfaces are wired transmission interfaces or wireless transmission interfaces. Where a games controller functions as the input unit 320, wireless transmission interfaces are preferably disposed between the third transmission unit of the expansion input/output device 300 and the display device 20 to facilitate the user's operation and control.

Accordingly, the present invention provides an expansion input/output device coupled to a handheld electronic device for treating the handheld electronic device as a computation processing center, integrating the input function of the input unit to effectuate a user-friendly input interface, sending an audio/video signal of the handheld electronic device to an external display device, so as to provide a large display view, expand the applicability and integration capacity of the handheld electronic device, and enhance ease of use. Hence, users will find the expansion input/output device of the present invention useful and convenient, such that a handheld electronic device with high mobility can work as efficiently as the hardware system of a personal computer.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An expansion input/output device electrically connected to a display device and coupled to a handheld electronic device having a first transmission unit, the handheld electronic device being adapted to generate an audio/video signal, the expansion input/output device comprising:
a body having a receiving space for receiving the handheld electronic device;
an input unit disposed on the body for generating a control signal based on an input entered by a user;
a second transmission unit disposed on the body and electrically connected to the input unit and the first transmission unit for transmitting the control signal and receiving the audio/video signal and thereby controlling and operating the handheld electronic device based on the control signal; and
a third transmission unit disposed on the body and electrically connected to the second transmission unit and the display device for transmitting the audio/video signal to the display device and displaying the audio/video signal on the display device.

2. The expansion input/output device of claim 1, wherein the third transmission unit comprises a signal converter for performing a conversion process on the audio/video signal based on a transmission interface of the display device.

3. The expansion input/output device of claim 2, wherein transmission interfaces of the display device are wired transmission interfaces or wireless transmission interfaces.

4. The expansion input/output device of claim 2, wherein transmission interfaces of the second transmission unit and the display device are at least one selected from the group consisting of an HDMI, a VGA interface, a DVI, a DisplayPort, a USB interface, a Bluetooth interface, an NFC interface, an AV terminal interface, an S terminal interface, and a chromatic aberration terminal interface.

5. The expansion input/output device of claim 1, wherein the input unit is a computer peripheral input device.

6. The expansion input/output device of claim 5, wherein the input unit is one of a keyboard, a games controller, a hand-writing panel, and a mouse.

7. The expansion input/output device of claim 1, wherein wired transmission interfaces or wireless transmission interfaces are disposed between the first transmission unit and the second transmission unit.

8. The expansion input/output device of claim 7, wherein transmission interfaces of the first transmission unit and the second transmission unit are at least one selected from the group consisting of an HDMI, a VGA interface, a DVI, a DisplayPort, a USB interface, a Bluetooth interface, and an NFC interface.

9. The expansion input/output device of claim 1, wherein the display device is one of a television screen, a liquid crystal display, and a plasma display.

10. The expansion input/output device of claim 1, further comprising a clamping unit disposed in the receiving space and having at least one adjusting member for adjusting the clamping unit and thereby clamping and fixing the handheld electronic device.
